(19) United States
(12) Patent Application Publication
(10) Pub. No.: US 2005/0093339 A1
(43) Pub. Date: May 5, 2005

(54) Truck with folding sidewalls

(76) Inventor: Michael J. Klassen, Aberdeen, ID (US)

Correspondence Address: BLACK LOWE & GRAHAM, PLLC, 701 FIFTH AVENUE, SUITE 4800, SEATTLE, WA, 98104, US

(21) Appl. No.: 10/770,102

(22) Filed: Feb. 2, 2004

Related U.S. Application Data
(60) Provisional application No. 60/516,127, filed on Oct. 30, 2003.

(51) Int. Cl. B62D 33/03

(52) U.S. Cl. 296/183.1

(57) ABSTRACT

A pickup truck includes a cab and a bed with sidewalls. In most forms, the bed will also include a tailgate that may be closed in an upright position that in most cases will be substantially vertical, and opened in a horizontal position. Each of the sidewalls can also be deployed, moving from a closed upright position to an open horizontal position. Optional features include a tonneau cover that may be secured atop the bed or raised to an elevated position.

### PRIORITY CLAIM

This invention claims priority from U.S. Provisional Application No. 60/516,127, entitled “TRUCK WITH FOLDING SIDEWALLS,” filed Oct. 31, 2003.

### FIELD OF THE INVENTION

This invention relates generally to trucks, including pickup and similar trucks having a bed with sidewalls.

### BACKGROUND OF THE INVENTION

Pickup trucks are very popular for their versatility. The truck bed is useful for hauling loads to worksites, moving household goods, and many other tasks. The folding tailgate allows access to the cargo in the bed and facilitates loading.

Because of this versatility, pickup trucks are frequently also used for tailgate parties. Coolers, barbeques, and picnic items can be loaded into the bed and driven to a sporting event, picnic site, or other location. Upon arrival, the tailgate is lowered and used as a makeshift table to provide access to the picnic supplies. The pickup therefore provides a handy vehicle for use as a portable barbeque or picnic.

Although pickup trucks are very useful for tailgate parties and the like, there are drawbacks. For example, it is often difficult to retrieve the items from the bed of the pickup. In order to reach them, one must often climb into the bed itself. In addition, while the tailgate is a useful work surface or makeshift table, it often is not large enough for certain tasks. As such, it is frequently necessary to haul an additional table or workbench to the worksite or tailgate party. Similarly, many tailgaters find it convenient to sit on the tailgate. But if the tailgate is used as a chair it cannot also be conveniently used as a table surface. There is a need, therefore, for an improved truck bed that overcomes some or all of these problems.

Many pickup trucks also include tonneau covers or similar structures covering the bed of the truck. Such devices are quite useful to protect the cargo from rain, wind, or other elements, and to retain the cargo within the bed during travel. They can be inconvenient to secure and to remove, however. Consequently, many truck bed covers make it difficult to gain access to the cargo in the bed. In addition, tonneau and similar covers generally must be either fully installed or fully removed, so that a user must choose between protecting the cargo from the elements and gaining access to the cargo. There is a need, therefore, for an improved tonneau cover that protects truck cargo during transit but that also may be raised to a position that allows access while still protecting the contents of the bed.

### SUMMARY OF THE INVENTION

The preferred pickup truck includes a cab and a bed with sidewalls. In most forms, the bed will also include a tailgate that may be closed in an upright position that in most cases will be substantially vertical, and opened in a horizontal position. Each of the sidewalls can also be deployed, moving from a closed upright position to an open horizontal position.

In accordance with various alternate forms of the invention, the truck sidewalls can include a pneumatic actuator, an air bag, air ram, electric screw, or counterbalance weights in order to better facilitate raising and lowering of the sidewalls. In addition, the sidewalls can be locked using a post and pawl latch arrangement, or can include movable screws, pins, or other devices that may be either mechanically or electrically operated.

In preferred forms of the invention, additional structural support is provided within the sidewalls by means of a subframe of steel beams. One or more of the sidewall beams pivotally attaches to a truck frame member beneath the truck bed to facilitate pivotal operation of the sidewalls. Other arrangements are also possible to enable the sidewalls to pivot downward, including piano hinges with the bed or other devices.

In some embodiments, the truck includes a tonneau cover secured atop the truck bed. Preferably, the truck cover is at least semi-rigid and is secured at the four corners of the truck bed. At each of the four corners, a telescoping post is deployable from a lowered position to a raised position, allowing the tonneau cover to be moved from a position snugly atop the sidewalls to a raised position. The raised position is ideally at a height approximately parallel with the top of the truck cab, but may be at a position higher or lower than the cab. The telescoping posts can also be automatically or mechanically operated.

The preferred construction of the pickup with folding sidewalls employs vertical posts at each of the comers of the truck bed. The tailgate and sidewalls latch to the comer posts, providing structural rigidity when the sidewalls and tailgate are raised. In alternate forms, the comer posts are not used and the tailgate and sidewalls latch to one another instead.

### BRIEF DESCRIPTION OF THE DRAWINGS

The preferred and alternative embodiments of the present invention are described in detail below with reference to the following drawings.

FIG. 1 is a perspective view of a pickup with sidewalls in an upright position;

FIG. 2 is a perspective view of a pickup with a tonneau cover extended vertically;

FIG. 3 is a perspective view of a pickup with an extended tonneau cover and the tailgate and sidewalls deployed vertically;

FIG. 4 is a perspective view of a pickup truck without a tonneau cover and with the tailgate and sidewalls deployed horizontally;

FIG. 5 is a perspective view of a folding truck sidewall, with internal structural reinforcements visible;

FIG. 6 is a top plan view of a truck bed with the tailgate and sidewalls folded down horizontally; and

FIG. 7 is a rear view of a pair of pivotable truck sidewalls.

### DETAILED DESCRIPTION OF THE PREFERRED EMBODIMENT

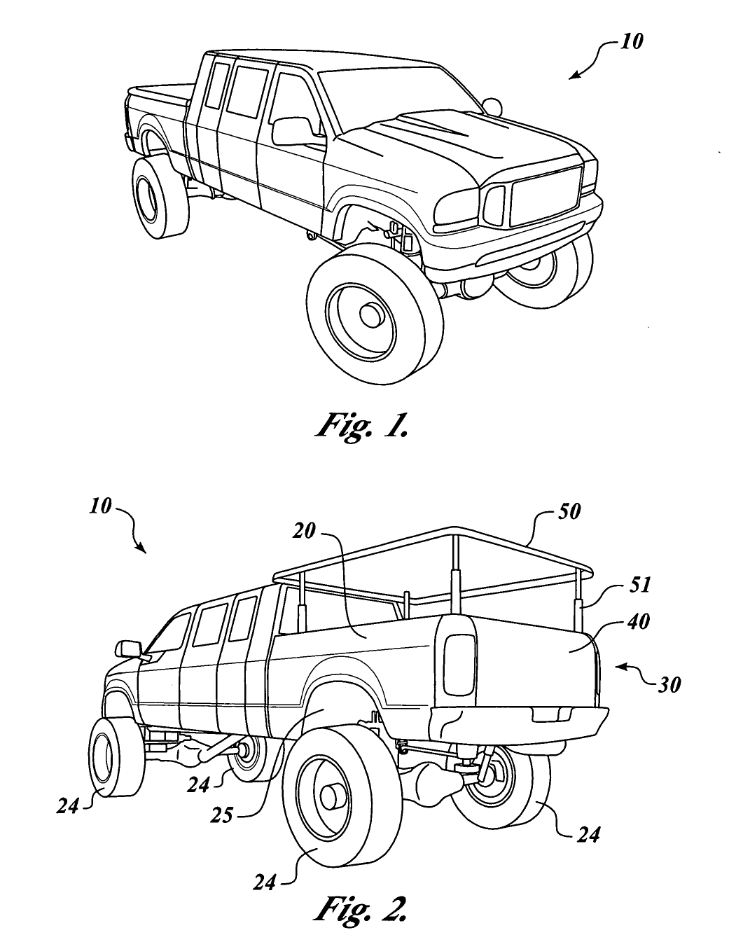

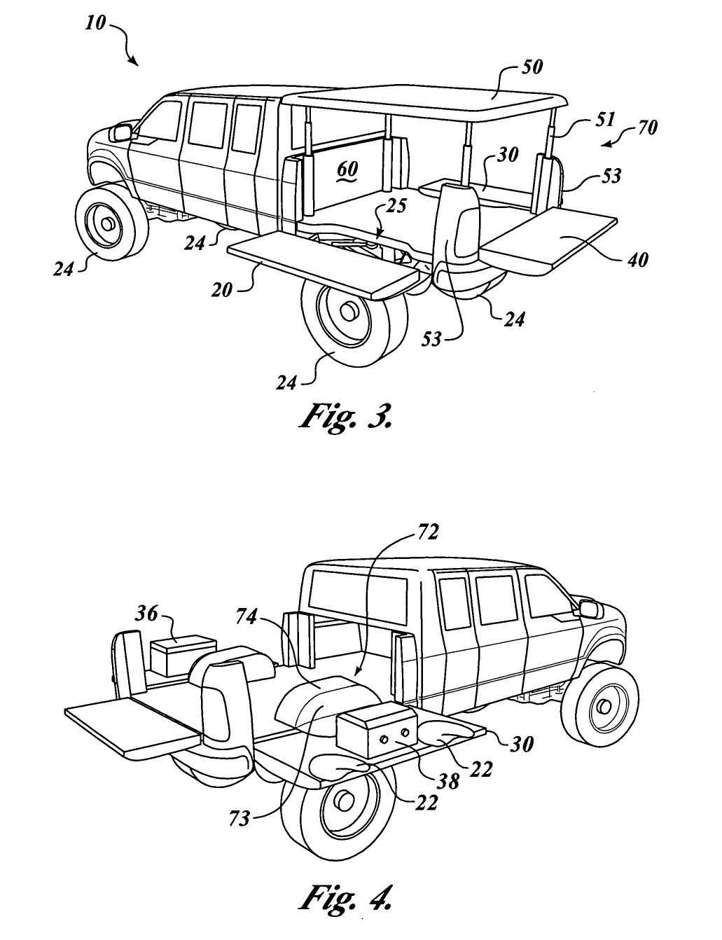

FIG. 1 depicts a pickup truck 10 configured for driving, with sidewalls and a tailgate in a vertical position to form a truck bed. The truck bed includes a floor, the floor having a front region toward the cab, a left region at the left side of the truck, a right region at the right side of the truck, and a rear region at the rear of the truck. Although a pickup truck is used in the preferred form, the invention works equally well with any vehicle having sidewalls. In the preferred embodiment, the sidewalls and tailgate fold downward to a horizontal position, as best seen in FIGS. 3 and 4. The sidewalls are preferably formed from steel, aluminum, fiberglass, or other typical materials as would be used in constructing a pickup truck body. They may be configured at the time of original manufacture for opening and closing, or a truck with fixed sidewalls may be modified to enable the sidewalls to open and close.

A tonneau cover 50 is also shown atop the tailgate and sidewalls. The tonneau cover is an optional feature included in certain embodiments, and need not be included as part of the invention. As shown in FIG. 2, the preferred tonneau cover 50 is at least semi-rigid, and is therefore formed from hard plastic or other similar materials. Alternatively, the tonneau cover 50 can be made from leather, vinyl, or other flexible materials and attached in a manner that is slightly stretched across the truck bed to provide a substantially horizontal surface, or that includes a rigid support structure. In the form of FIG. 2, the tonneau cover is generally rectangular in shape, having an upper surface, a lower surface, and four comers. Each of the four corners is rounded slightly to accommodate the shape of the pickup bed. In addition, the cover 50 is curved downward slightly about its perimeter to form a shoulder to ensure that water will drain to the exterior of the pickup bed.

The cover 50 is attached at each of its four corners to four extendable supports, which preferably comprise telescoping poles 51. The telescoping poles 51, in turn, are secured to the pickup substantially at each of the four corners of the bed. At the rear of the bed, the posts are secured adjacent to and just inside a pair of comer posts 53 that also serve as a structural support for latching the sidewalls and tailgate. The telescoping posts preferably are driven by an electric screw ram in signal communication with a dashboard-mounted or wireless remote switch. In alternate embodiments, the posts may include pneumatic, hydraulic, air-ram, or other structures to extend the cover 50 from a lowered to a raised position. In yet other forms, the cover 50 may be supported by fewer or more than four supports. For example, the cover 50 may be supported by three supports, with one adjacent each of the tailgate comer posts 53, and a third post at the forward center of the bed, adjacent the rear cab window.

FIG. 3 depicts the sidewalls and tailgate all deployed in a horizontal position. FIG. 2 depicts a pickup having a bed defined by a left sidewall 20, a right sidewall 30, a forward cab wall 60, a tailgate 40, and a floor 70. In FIG. 3, the left and right sidewalls 20, 30 and tailgate 40 are pivoted downward to a horizontal position such that they are each substantially parallel with the floor 70. The result is a truck having a large, extended floor surface area for construction, tailgating, or other activities.

FIG. 4 illustrates another embodiment in which the tonneau cover 50 is removed. In addition, the sidewalls 20, 30 of the embodiment of FIG. 4 are modified slightly. A number of seats 22 are integrally-molded into the sidewalls and oriented to accommodate a person sitting toward an outer edge of the sidewall when the sidewall is deployed horizontally. Any number of such molded seats can be attached to or formed in the left sidewall 20, right sidewall 30, or tailgate 40.

In addition, the embodiment of FIG. 4 depicts wheel wells 72 formed within the floor 70 of the truck bed. The inclusion of a wheel well is typical in pickup trucks, but is not an essential part of the present invention. If the bed of the truck is narrow or high enough to clear the tires in all cases, no wheel well would be required. In other forms, the wheel well, or a portion of it, can be built into the sidewalls. Thus, as seen in FIG. 2, an approximately semi-circular section is removed from the exterior side of the sidewall 20 to form a wheel well 25 in order to accommodate the adjacent tire 24. Depending on clearance, bed width, sidewall thickness, or other factors, the interior side of the sidewall 20 may be flat, without a wheel well cutout.

In other embodiments, the wheel well may be incorporated entirely into the floor 70 of the truck bed, so that no cutout or other tire accommodation is required in the sidewalls. As best seen in FIG. 4, the wheel well 72 includes a curved upper surface 74 and a generally vertical exterior surface 73. The interior surface faces toward the middle of the truck bed. An exterior surface is also generally vertical and faces away from the middle of the truck bed, toward the inner surface of the sidewall. When the sidewall 20 is closed, the inner surface of the sidewall abuts the exterior surface of the wheel well.

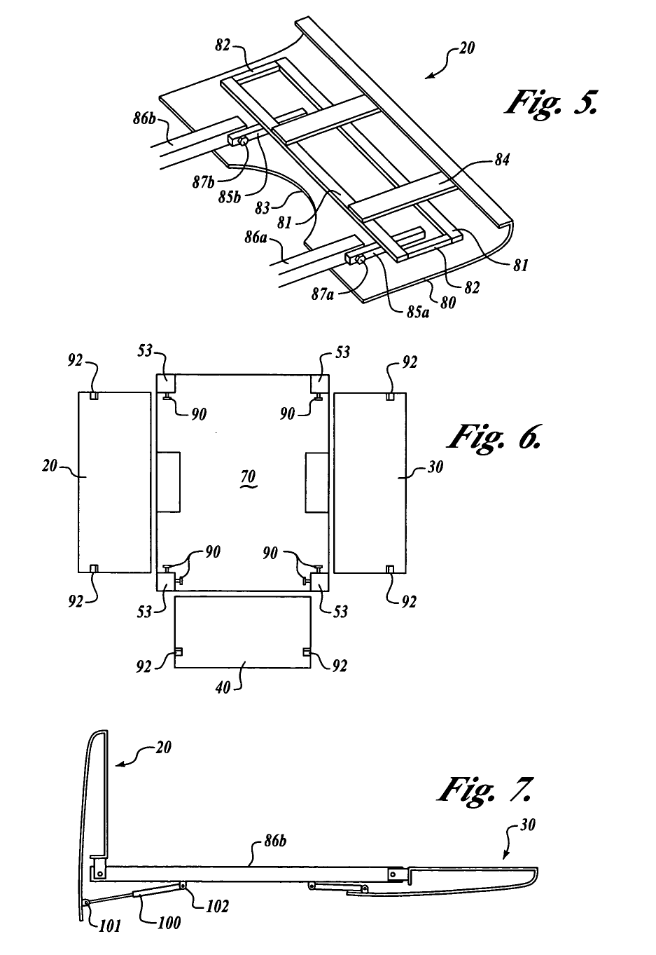

FIG. 5 illustrates a preferred sidewall construction, showing internal support members. In most cases, the sidewalls will be mirror opposites of one another, and for that reason only one sidewall is shown. The sidewalls may differ in a number of respects, however, such as the inclusion of integrally molded seats, barbeque attachments, or other features. The sidewall 20 includes an exterior wall 80 and an interior wall that is not illustrated in FIG. 5 so that the internal structure will be visible.

An internal subframe within the sidewall 20 includes one or more horizontal steel beams 81 and one or more vertical steel posts 82. As shown, two horizontal beams and two vertical posts are included. A pair of metal tie plates 84 are welded to the sidewall 20 and the subframe members.

The sidewall subframe is pivotally attached to the truck frame or chassis at either side of the wheel well 83. As noted above, the wheel well need not necessarily be provided in the sidewall. Likewise, the sidewalls may be pivotally connected to the frame at other locations. The truck frame includes a pair of beams 86a, 86b extending horizontally beneath the bed from one sidewall toward the other. The sidewalls similarly include a pair of sidewall subframe beams 85a, 85b located in a position such that when the sidewall is attached to the truck the sidewall subframe beams 85a, 85b will be adjacent the truck frame beams 86a, 86b the sidewall frame beams 85a, 85b are then pivotally attached to the truck frame beams 86a, 86b using bolts, pins, or other suitable hardware. While the pivotal connection is shown as a direct connection of beams joined by pins or bores, it may also be produced by a metal tab welded to either or both of the beams, with the pivotal connection being made with the tabs rather than the beams directly. Thus, as shown, the sidewalls 20, 30 can be pivotably moved through a variety of positions, including a generally horizontal position and a generally vertical position.

FIG. 6 depicts a top plan view of a truck bed 70 having folding sidewalls, with the tailgate 40 and sidewalls 20, 30 folded in a downward position. At each of the four comers of the truck bed 70 is a post 53. The posts provide structural support for the tailgate and sidewalls when in an upright position, so that each of the sidewalls and tailgate may be latched to the rigid posts.

The posts 53 each include one or more horizontal pins 90 that are configured to be received by corresponding slots 92 in the tailgate and sidewalls. Within each of the slots 92 is a pawl (not shown) adapted to engage the pins and hold the tailgate and sidewalls in an upright and locked position. Preferably, the pawl is pivotally mounted and can release the pin by pulling a handle that is connected to the pawl via a cable in much the same manner as a conventional tailgate lock and release mechanism. Alternatively, the pawl can be electronically pivotable to allow automatic and remote operation. Additional alternative lock and release mechanisms may also be used, such as pins that are retractable and extendible into and out of the posts, retractable screws, hydraulics, and others.

In yet another alternative, the latching posts 53 may be eliminated altogether. While the posts provide an extra measure of rigidity and strength that is useful for certain loads that may be carried in the bed, they can be eliminated. Instead, the tailgate and sidewalls may simply fold upward and latch to one another rather than to the posts. In one such embodiment, the sidewalls may each include slots and latches, as described above. The tailgate, however, may include outwardly extending pins that engage the slots and pawls as described above. Thus, the pins of the tailgate engage the slots and pawls of the sidewalls to join the two together.

It can be valuable for the sidewalls 20, 30 to be controlled so that they can be secured in a horizontal position, and also to provide a counterforce urging the sidewalls upward to act against the downward force of the sidewalls when deployed. Likewise, it is useful to have a means for raising and lowering the sidewalls, preferably in an automatic fashion. Several alternative structures can accomplish this purpose. In a preferred form, as shown in FIG. 7, a hydraulic cylinder 100 is pivotally attached at a first end to a metal tab 102 depending downward from a frame beam 86b and pivotally attached at a second end to a metal tab 101 attached to the sidewall (either the sidewall directly or the sidewall subframe). The hydraulic cylinder therefore restricts the movement of the sidewall and, properly configured, can maintain the sidewall in a horizontal position when pivoted downward and automatically raise and lower the sidewall. The hydraulic cylinder can also help to counteract the weight of the sidewall. As it pivots downward, the sidewall will be quite heavy and could drop quickly, potentially injuring a user. The pneumatic cylinder can act against the downward force of the sidewall, allowing it to be pivoted downward in a slow and controlled fashion.

Additional or alternative devices may be used to control the movement of the sidewall and maintain it in a horizontal position. For example, stops may be secured to the frame or subframe such that the stop is engaged once a horizontal position is reached. A counterbalance weight can be attached to the lower end of the sidewall (below the pivot point) to act against some of the weight of the sidewall. In yet other embodiments, an air ram, air bag, air actuator, electric screw, hydraulics, pneumatic cylinder, or other devices can be used as a means to raise and lower the sidewalls, or to otherwise control the pivotal movement of the sidewalls and tailgate.

Many of the above devices can be either mechanically or electronically controlled. Those that are electronically controllable, such as an electric screw or hydraulics, enable an automatic operation of the pivotal movement of the sidewalls and tailgate. Thus, an electric screw secured in the place of the hydraulic cylinder 100 can be used to automatically raise and lower the sidewalls and tailgate by operating the screw in one direction or the other. An electronic device such as an electric screw may also be operated via a local switch, a dashboard-mounted switch, or a button on a remote control device.

While the sidewalls are pivotally connected in the preferred embodiment, the sidewalls may optionally be removed altogether. By removing the pin or bolt pivotally securing the sidewall to the frame, the sidewalls may be removed to allow the truck to haul certain loads that are better accommodated with a flat bed and no extended sidewalls.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A pickup truck having a front, a back, a left side, and a right side, the truck comprising:
a cab;
a left sidewall attached to the left side of the truck;
a right sidewall attached to the right side of the truck; and
a truck bed defined by a floor, the left sidewall, and the right sidewall;
wherein at least one of the left sidewall or right sidewall is movable from an upright position to a deployed position.

2. The pickup truck of claim 1, wherein the deployed position comprises a substantially horizontal position.

3. The pickup truck of claim 2, wherein both the left sidewall and right sidewall are movable from an upright position to a substantially horizontal position.

4. The pickup of claim 3, further comprising a tailgate, wherein the tailgate is movable from an upright position to a substantially horizontal position.

5. The pickup of claim 4, further comprising a truck frame, and wherein the left sidewall and right sidewall are each pivotally attached to the truck frame.

6. The pickup of claim 5, further comprising a means for urging the sidewalls in an upright position.

7. The pickup of claim 6, wherein the means for urging comprises a hydraulic cylinder.

8. The pickup of claim 6, wherein the means for urging comprises a counterweight.

9. The pickup of claim 6, wherein the means for urging comprises a spring.

10. The pickup of claim 4, further comprising a first post extending upward from the truck, the post being configured to enable at least one of the left sidewall, right sidewall, or tailgate to be latched to the post.

11. The pickup of claim 10, further comprising a second post extending upward from the truck, the second post being configured to enable at least one of the left sidewall, right sidewall, or tailgate to be latched to the post.

12. The pickup of claim 4, further comprising a tonneau cover atop the truck bed.

13. The pickup of claim 12, further comprising a plurality of upwardly extendable supports, each of the supports having a first end secured to the truck and a second end secured to the tonneau cover, wherein the supports are movable from a first lowered position to a second raised position to thereby raise and lower the tonneau cover.

14. The pickup of claim 4, wherein at least one of the left sidewall or right sidewall comprises an interior wall facing toward the bed when upright and an exterior wall facing away from the bed when upright, the interior wall further comprising an integrally molded seat.

15. A pickup truck, comprising:
a cab;
a truck frame supporting a bed floor;
a first sidewall pivotally attached to the truck frame;
a second sidewall pivotally attached to the truck frame; and
a tailgate pivotally attached to the truck, wherein the floor, first sidewall, second sidewall, and tailgate define a truck bed.

16. The pickup truck of claim 15, further comprising a means for raising the first sidewall.

17. The pickup truck of claim 16, further comprising a means for raising the second sidewall.

18. The pickup truck of claim 17, further comprising a tonneau cover secured over the truck bed and a means for moving the tonneau cover from a first position over the truck bed to a second position over the truck bed that is relatively higher than the first position.

19. The pickup truck of claim 16, wherein the means for raising comprises a hydraulic cylinder.

20. The pickup truck of claim 16, wherein the means for raising comprises an electric screw.
